(19) United States
(12) Patent Application Publication
(10) Pub. No.: US 2025/0039736 A1
(43) Pub. Date: Jan. 30, 2025

(54) INTER-NETWORK CONGESTION REPORTING

(71) Applicant: NOKIA TECHNOLOGIES OY, Espoo (FI)

(72) Inventors: Bighnaraj PANIGRAHI, Bangalore (IN); Saubhagya BALIARSINGH, Bengaluru (IN)

(21) Appl. No.: 18/748,498

(22) Filed: Jun. 20, 2024

(30) Foreign Application Priority Data
Jul. 28, 2023 (IN) 202341051041

(51) Int. Cl. H04W 28/02; H04W 24/10

(52) U.S. Cl. CPC H04W 28/0289; H04W 24/10; H04W 28/0284

(57) ABSTRACT

There are provided measures for inter-network congestion reporting. Such measures may comprise (e.g. at a network gateway entity providing access to a network for a network external entity external to said network) receiving, from an entity external to a first network, a report reporting congestion indication in a downlink direction from said first network towards a terminal device, and transmitting information corresponding to said congestion indication towards a network entity in said first network.

### CROSS REFERENCE TO RELATED APPLICATION

This application claims the benefit of Indian Provisional Application No. 202341051041, filed Jul. 28, 2023. The entire content of the above-referenced application is hereby incorporated by reference.

### TECHNICAL FIELD

Various example embodiments of this subject disclosure relate to inter-network congestion reporting. More specifically, the various example embodiments relate to measures (including methods, apparatuses and computer program products) for realizing inter-network congestion reporting.

### BACKGROUND

A communication system can be seen as a facility that enables communication sessions between two or more entities such as communication devices, base stations and/or other nodes by providing carriers between the various entities involved in the communications path.

The communication system may be a wireless communication system. Examples of wireless systems comprise public land mobile networks (PLMN) operating based on radio standards (such as, those provided by 3GPP), satellite based communication systems and different wireless local networks. A wireless local network may, for example, be implemented as a wireless local area network (WLAN). The wireless systems can typically be divided into cells, and are therefore often referred to as cellular systems.

The communication system and associated devices typically operate in accordance with a given standard or specification which sets forth what the various entities associated with the system are permitted to do and how that should be achieved. Communication protocols and/or parameters which shall be used for the connection are also typically defined. An example of a set of standards are the so-called 5G standards.

### SUMMARY

Various example embodiments aim at addressing at least part of the issues and/or problems and drawbacks either explicitly described herein or otherwise apparent to a person skilled in the relevant arts in view of the subject disclosure.

Several aspects of the various example embodiments are detailed as follows.

According to an aspect, there is provided a method, comprising detecting congestion indication in a downlink direction from a first network towards a terminal device, and reporting said congestion information to a network entity of said first network.

According to an aspect, there is provided a method, comprising receiving, from an entity external to a first network, a report reporting congestion indication in a downlink direction from said first network towards a terminal device, and transmitting information corresponding to said congestion indication towards a network entity in said first network.

According to an aspect, there is provided a method, comprising receiving information indicating congestion indication in a downlink direction from a first network towards a terminal device, and transmitting said information towards a first network entity configured for downlink packet congestion notification marking.

According to an aspect, there is provided a method, comprising transmitting, towards a user plane function entity, a configuration to accept congestion information reported by a network entity, and/or transmitting, towards said network entity, a configuration to report congestion information to said user plane function entity.

According to an aspect, there is provided a method, comprising receiving information indicating congestion indication in a downlink direction from a first network towards a terminal device, and explicit congestion notification marking of downlink packets in said downlink direction according to the received information.

According to an aspect, there is provided a method, comprising receiving information indicating congestion indication in a downlink direction from a first network towards a terminal device, and transmitting said information towards an application function entity.

According to an aspect, there is provided an apparatus, comprising detecting circuitry configured to detect congestion indication in a downlink direction from a first network towards a terminal device, and reporting circuitry configured to report said congestion information to a network entity of said first network.

According to an aspect, there is provided an apparatus, comprising receiving circuitry configured to receive, from an entity external to a first network, a report reporting congestion indication in a downlink direction from said first network towards a terminal device, and transmitting circuitry configured to transmit information corresponding to said congestion indication towards a network entity in said first network.

According to an aspect, there is provided an apparatus, comprising receiving circuitry configured to receive information indicating congestion indication in a downlink direction from a first network towards a terminal device, and transmitting circuitry configured to transmit said information towards a first network entity configured for downlink packet congestion notification marking.

According to an aspect, there is provided an apparatus, comprising transmitting circuitry configured to transmit, towards a user plane function entity, a configuration to accept congestion information reported by a network entity, and/or to transmit, towards said network entity, a configuration to report congestion information to said user plane function entity.

According to an aspect, there is provided an apparatus, comprising receiving circuitry configured to receive information indicating congestion indication in a downlink direction from a first network towards a terminal device, and marking circuitry configured to explicit congestion notification mark downlink packets in said downlink direction according to the received information.

According to an aspect, there is provided an apparatus, comprising receiving circuitry configured to receive information indicating congestion indication in a downlink direction from a first network towards a terminal device, and transmitting circuitry configured to transmit said information towards an application function entity.

According to an aspect, there is provided an apparatus, comprising at least one processor, at least one memory including computer program code, and at least one interface configured for communication with at least another apparatus, the at least one processor, with the at least one memory and the computer program code, being configured to cause the apparatus to perform detecting congestion indication in a downlink direction from a first network towards a terminal device, and reporting said congestion information to a network entity of said first network.

According to an aspect, there is provided an apparatus, comprising at least one processor, at least one memory including computer program code, and at least one interface configured for communication with at least another apparatus, the at least one processor, with the at least one memory and the computer program code, being configured to cause the apparatus to perform receiving, from an entity external to a first network, a report reporting congestion indication in a downlink direction from said first network towards a terminal device, and transmitting information corresponding to said congestion indication towards a network entity in said first network.

According to an aspect, there is provided an apparatus, comprising at least one processor, at least one memory including computer program code, and at least one interface configured for communication with at least another apparatus, the at least one processor, with the at least one memory and the computer program code, being configured to cause the apparatus to perform receiving information indicating congestion indication in a downlink direction from a first network towards a terminal device, and transmitting said information towards a first network entity configured for downlink packet congestion notification marking.

According to an aspect, there is provided an apparatus, comprising at least one processor, at least one memory including computer program code, and at least one interface configured for communication with at least another apparatus, the at least one processor, with the at least one memory and the computer program code, being configured to cause the apparatus to perform transmitting, towards a user plane function entity, a configuration to accept congestion information reported by a network entity, and/or transmitting, towards said network entity, a configuration to report congestion information to said user plane function entity.

According to an aspect, there is provided an apparatus, comprising at least one processor, at least one memory including computer program code, and at least one interface configured for communication with at least another apparatus, the at least one processor, with the at least one memory and the computer program code, being configured to cause the apparatus to perform receiving information indicating congestion indication in a downlink direction from a first network towards a terminal device, and explicit congestion notification marking of downlink packets in said downlink direction according to the received information.

According to an aspect, there is provided an apparatus, comprising at least one processor, at least one memory including computer program code, and at least one interface configured for communication with at least another apparatus, the at least one processor, with the at least one memory and the computer program code, being configured to cause the apparatus to perform receiving information indicating congestion indication in a downlink direction from a first network towards a terminal device, and transmitting said information towards an application function entity.

According to an aspect, there is provided a computer program product comprising computer-executable computer program code which, when the program is run on a computer (e.g. a computer of an apparatus according to any one of the aforementioned apparatus-related aspects of the subject disclosure), is configured to cause the computer to carry out the method according to any one of the aforementioned method-related aspects of the subject disclosure.

Such computer program product may comprise (or be embodied) a (tangible) computer-readable (storage) medium or the like on which the computer-executable computer program code is stored, and/or the program may be directly loadable into an internal memory of the computer or a processor thereof.

Any one of the above aspects or other aspects described herein facilitates an optimized provision and exploitation of congestion reporting possibilities to thereby address at least part of any issues and drawbacks identified herein or otherwise apparent to a person skilled in the relevant arts in view of the subject disclosure.

In some example embodiments, there is provided inter-network congestion reporting. More specifically, there are provided measures and mechanisms for realizing inter-network congestion reporting.

Thus, optimization may be achieved by methods, apparatuses and computer program products enabling/realizing inter-network congestion reporting.

### BRIEF DESCRIPTION OF THE DRAWINGS

In the following, some example embodiments will be described in greater detail, by way of non-limiting and illustrative examples, with reference to the accompanying drawings, in which:

FIG. 1 is a block diagram illustrating an apparatus according to some example embodiments,

FIG. 2 is a block diagram illustrating an apparatus according to some example embodiments,

FIG. 3 is a block diagram illustrating an apparatus according to some example embodiments,

FIG. 4 is a block diagram illustrating an apparatus according to some example embodiments,

FIG. 5 is a block diagram illustrating an apparatus according to some example embodiments,

FIG. 6 is a block diagram illustrating an apparatus according to some example embodiments,

FIG. 7 is a block diagram illustrating an apparatus according to some example embodiments,

FIG. 8 is a block diagram illustrating an apparatus according to some example embodiments,

FIG. 9 is a schematic diagram of a procedure according to some example embodiments,

FIG. 10 is a schematic diagram of a procedure according to some example embodiments,

FIG. 11 is a schematic diagram of a procedure according to some example embodiments,

FIG. 12 is a schematic diagram of a procedure according to some example embodiments,

FIG. 13 is a schematic diagram of a procedure according to some example embodiments,

FIG. 14 is a schematic diagram of a procedure according to some example embodiments,

FIG. 15 shows a schematic diagram of an example of a system environment with signaling variants,

FIG. 16 shows a schematic diagram of an example of a system environment with signaling variants according to some example embodiments,

FIG. 17 shows a schematic diagram of an example of a protocol stack according to some example embodiments,

FIG. 18 shows a schematic diagram of signaling sequences according to some example embodiments,

FIG. 19 shows a schematic diagram of an example of a protocol stack according to some example embodiments,

FIG. 20 shows a schematic diagram of an example of a system environment with signaling variants according to some example embodiments, and

FIG. 21 is a block diagram alternatively illustrating apparatuses according to some example embodiments.

### DETAILED DESCRIPTION

The subject disclosure is described herein with reference to particular non-limiting and illustrative examples. A person skilled in the art will appreciate that the subject disclosure is by no means limited to these examples, and may be more broadly applied.

It is to be noted that the following description of the subject disclosure and its various embodiments refers to specifications being used as non-limiting and illustrative examples for certain network configurations and deployments. Namely, the subject disclosure and its various example embodiments are described in relation to 3GPP specifications being used as non-limiting and illustrative examples for certain network configurations and deployments. As such, the description of such example embodiments provided herein specifically refers to terminology which is directly related thereto. Such terminology is only used in the context of the non-limiting and illustrative examples, and is not intended to limit the subject disclosure in any way. Rather, any other communication or communication related system deployment, etc. may also be utilized.

Hereinafter, various example embodiments and implementations of the subject disclosure and its aspects are described using several variants and/or alternatives. It is generally noted that, according to certain constraints, all of the described variants and/or alternatives may be provided alone or in any combination (also including combinations of individual features of the various variants and/or alternatives).

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

There is provided a means configured for congestion handling and communications in relation to congestion handling. As further detailed herein, one or more issues can arise in reporting and handling of congestion in specific inter-network scenarios that are not arranged for. Inter-network congestion reporting may provide advantages and optimizations for certain use cases.

According to some example embodiments, there are provided measures and mechanisms for (enabling/realizing) inter-network congestion reporting.

A low latency, low loss scalable throughput (L4S) service may allow network administrators to configure their routers' active queue management (AQM) to mark packets as per congestion experienced (CE) if the queueing delay threshold is exceeded.

The L4S compatible transport/higher layers could then deduce the amount of congestion by the ratio of normal versus CE-marked packets and thus could then be able to reduce the sending rate accordingly.

During normal operation, this method would completely avoid packet drops caused by congestion and retain high utilization and low latency.

The explicit congestion notification (ECN) algorithm has (only) one responsibility to inform the sender about congestion building at the routers. Hence, ECN is a congestion notification or congestion signalling algorithm. ECN informs the sender about congestion so that respective measures can be taken to avoid building congestion. ECN marking may be used for L4S traffic.

To support eXtended reality (XR) in 3rd Generation Partnership Project (3GPP) networks, mechanisms were studied that enable codec/rate adaptation to meet requirements for services.

Two ways the congestion information can be conveyed back to the application (for rate adaptation) may be considered.

Option 1 (By enabling L4S): 5th Generation (5G) system may use ECN marking for the purpose of L4S for uplink and/or downlink quality of service (QoS) flows via one of the following two methods. A QoS flow level explicit indication may be provided to packet data unit (PDU) session anchor (PSA) user plane function (UPF) to enable the ECN marking for the purpose of L4S.

Method 1: To support L4S, next generation radio access network (NG-RAN) performs ECN marking for uplink and downlink in internet protocol (IP) layer of the received packets.

Method 2: PSA UPF performs ECN marking for uplink (UL) and downlink (DL) IP layer of the received packets based on latest reported congestion information from NG-RAN via General Packet Radio System (GPRS) tunnelling protocol user plane (GTP-U) header. When no congestion is present or congestion ends, the PSA UPF stops ECN marking.

Option 2 (via application programming interface (API) based exposure): 5G system also may support API based exposure of congestion level information towards an application function (AF).

The host may need to distinguish L4S and classic/non-L4S traffic packets with an identifier (e.g., ECT), so that the network can identify and classify them into their separate treatments.

In relation to eXtended reality and media services (XRM), L4S for non-3GPP access (trusted, untrusted, wireline) may become relevant.

A scenario where user equipment (UE), being an example for terminals or terminal devices, are accessing the XRM service using 5G core (5GC) and non-3GPP access, and the non-3GPP access is experiencing congestion, is assumed and considered.

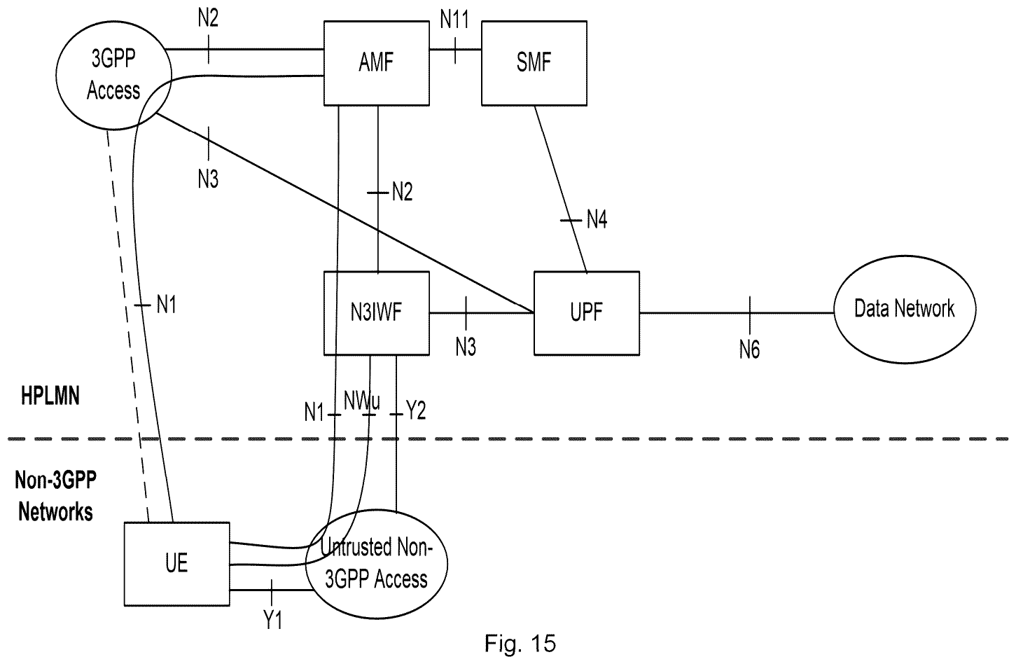

FIG. 15 shows a schematic diagram of an example of a system environment with signaling variants, and in particular illustrates such scenario.

Assuming that the non-3GPP WLAN device (e.g., WiFi router) is L4S capable, and if the non-3GPP access is experiencing congestion, then there is no solution by which the non-3GPP access can report the congestion information to the 5GC so that the 5GC can take appropriate action (e.g., L4S mechanism).

Hence, a way is sought, by which L4S marking mechanism is enabled for the XRM traffic in non-3GPP access. Further, a way sought, by which a non-3GPP access node can send congestion information to the UPF for L4S marking. The way is not only sought for the XRM traffic scenario, but rather the solutions provided below are also applicable to scenarios including non-XRM traffic.

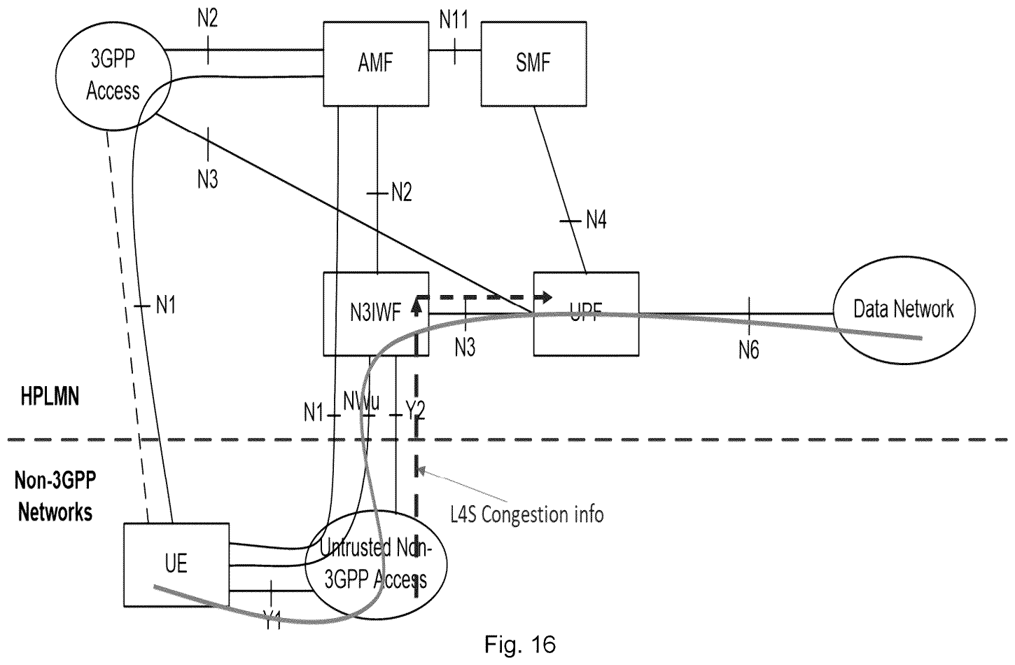

FIG. 16 shows a schematic diagram of an example of a system environment with signaling variants according to some example embodiments, and in particular illustrates XRM DL traffic via non-3GPP access and an L4S congestion information flow according to some example embodiments.

As shown in FIG. 16, XRM DL traffic is flowing towards the UE via non-3GPP access. It is further assumed that the non-3GPP access node (e.g., WLAN router) is L4S capable.

According to some example embodiments, the WLAN router/entity (i.e., the non-3GPP access entity) reports the congestion information to the 5GC via a non-3GPP interworking function (N3IWF), which is an example of a gateway entity.

Whenever the L4S enabled WLAN router/entity experiences congestion, according to some example embodiments, the WLAN router/entity enables the outer IP packets with ECN marks towards the N3IWF.

According to some example embodiments, the N3IWF is able to read/decode the ECN indications/packets in the UL direction (set by the WLAN) and determine that the WLAN is experiencing congestion in the DL direction.

According to some example embodiments, the N3IWF then reports congestion information (e.g., number of packets to be L4S ECN marked) to the session management function (SMF) via the access and mobility management function (AMF).

According to some example embodiments, the SMF then forwards the congestion information to UPF.

According to further example embodiments, the N3IWF may directly report the congestion information to the UPF via GTP-U.

According to further example embodiments, before the SMF can trigger the L4S marking indication to UPF, the SMF can query the N3IWF about whether the N3IWF can read/decode the ECN indication (set by WLAN).

According to still further example embodiments, the congestion information sent from the WLAN/N3IWF can also be sent to an AF using the API based exposure (Option-2 mentioned above). In this case, the UPF, when it receives the information from N3IWF, instead of marking the packets, forwards the congestion information towards the AF (e.g., using UPF enhancement for exposure and service-based architecture (SBA) (UPEAS) signaling).

According to still further example embodiments, the entry point considered above is not an untrusted non-3GPP entity, requiring a N3IWF as a gateway, but is instead a trusted non-3GPP entity, requiring a trusted non-3GPP gateway function (TNGF) as the gateway entity.

Several example embodiments are specified below in more detail.

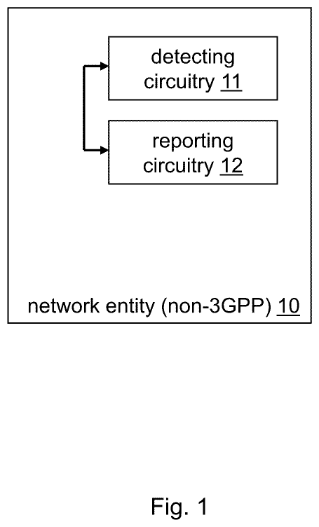

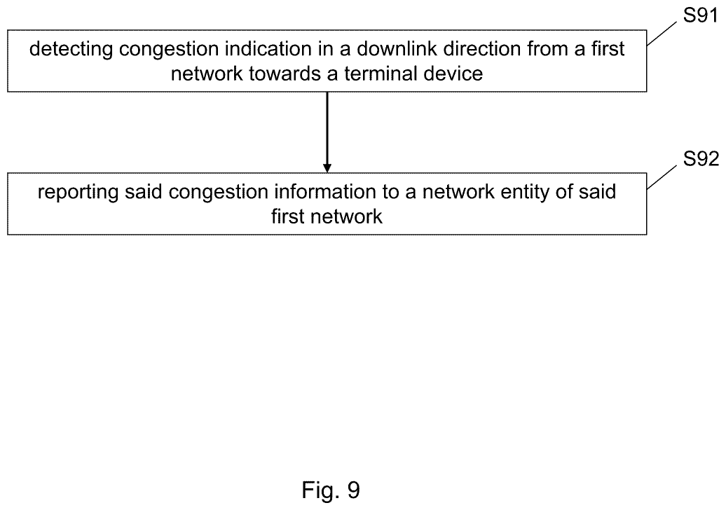

FIG. 1 is a block diagram illustrating an apparatus according to some example embodiments. The apparatus may be a network node or entity 10, such as a network external entity external to a network (e.g. non-3GPP access entity), providing (mobile) access to the network (e.g. a 3GPP network), e.g. a WLAN/WiFi router, comprising a detecting circuitry 11 and a reporting circuitry 12. The detecting circuitry 11 detects congestion indication in a downlink direction from a first network towards a terminal device. The reporting circuitry 12 reports said congestion information to a network entity of said first network. FIG. 9 is a schematic diagram of a procedure according to some example embodiments. The apparatus according to FIG. 1 may perform the method of FIG. 9 but is not limited to this method. The method of FIG. 9 may be performed by the apparatus of FIG. 1 but is not limited to being performed by this apparatus.

As shown in FIG. 9, a procedure according to some example embodiments comprises an operation of detecting (S91) congestion indication in a downlink direction from a first network towards a terminal device, and an operation of reporting (S92) said congestion information to a network entity of said first network.

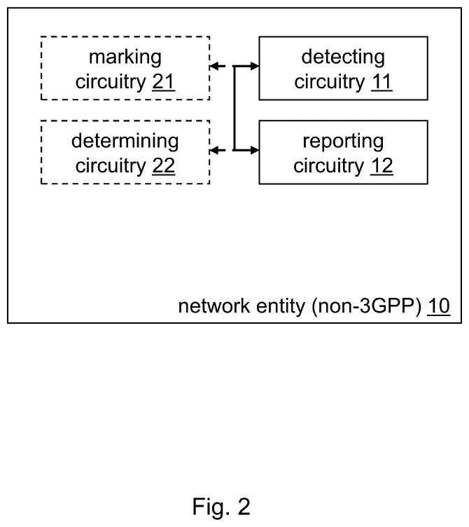

FIG. 2 is a block diagram illustrating an apparatus according to some example embodiments. In particular, FIG. 2 illustrates a variation of the apparatus shown in FIG. 1. The apparatus according to FIG. 2 may thus further comprise a marking circuitry 21 and/or a determining circuitry 22.

In an example embodiment, at least some of the functionalities of the apparatus shown in FIG. 1 (or FIG. 2) may be shared between two physically separate devices forming one operational entity. Therefore, the apparatus may be seen to depict the operational entity comprising one or more physically separate devices for executing at least some of the described processes.

According to a variation of the procedure shown in FIG. 9, details of the reporting operation (S92) are provided, which are inherently independent from each other as such. Such reporting operation (S92) according to some example embodiments may comprise an operation of explicit congestion notification marking of uplink packets towards said network entity of said first network.

According to further example embodiments, said uplink packets are outer internet protocol packets of a protocol stack structure including at least outer internet protocol packets and inner internet protocol packets contained in said respective outer internet protocol packets.

According to a variation of the procedure shown in FIG. 9, additional operations are provided, which are inherently independent from each other as such. According to such variation, a method according to some example embodiments may comprise an operation of determining a number of explicit congestion notification markings based on a level of said congestion indication and on a rate of downlink packets from the first network.

According to further example embodiments, said first network is a 3GPP network. According to such example embodiments, said method is operable at or by an untrusted non-3GPP access entity. According to such example embodiments, said network entity is a non-3GPP interworking function entity.

According to further example embodiments, said first network is a 3GPP network. According to such example embodiments, said method is operable at or by a trusted non-3GPP access entity. According to such example embodiments, said network entity is a trusted non-3GPP gateway function entity.

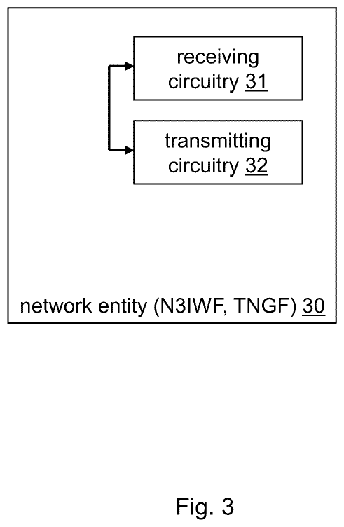

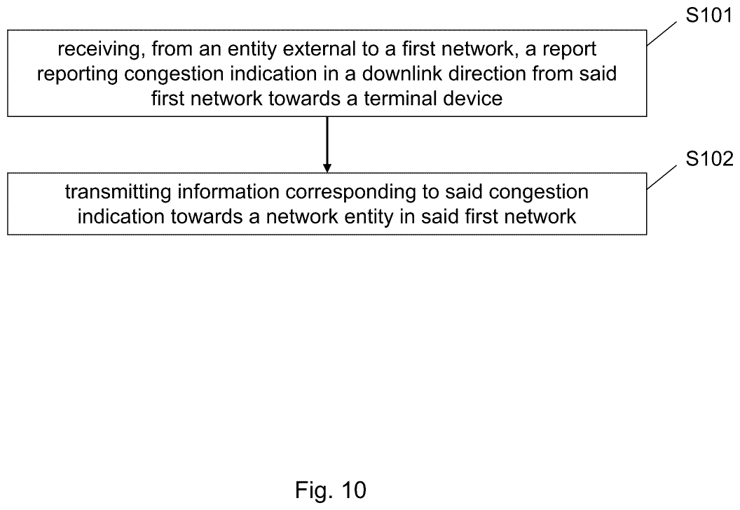

FIG. 3 is a block diagram illustrating an apparatus according to some example embodiments. The apparatus may be a network node or entity 30 such as a network gateway entity (e.g. non-3GPP to 3GPP access entity) providing access to a network (e.g. a 3GPP network) for a network external entity external to said network (e.g. a non-3GPP access entity), e.g. a N3IWF, TNGF, comprising a receiving circuitry 31 and a transmitting circuitry 32. The receiving circuitry 31 receives, from an entity external to a first network, a report reporting congestion indication in a downlink direction from said first network towards a terminal device. The transmitting circuitry 32 transmits information corresponding to said congestion indication towards a network entity in said first network. FIG. 10 is a schematic diagram of a procedure according to some example embodiments. The apparatus according to FIG. 3 may perform the method of FIG. 10 but is not limited to this method. The method of FIG. 10 may be performed by the apparatus of FIG. 3 but is not limited to being performed by this apparatus.

As shown in FIG. 10, a procedure according to some example embodiments comprises an operation of receiving (S101), from an entity external to a first network, a report reporting congestion indication in a downlink direction from said first network towards a terminal device, and an operation of transmitting (S102) information corresponding to said congestion indication towards a network entity in said first network.

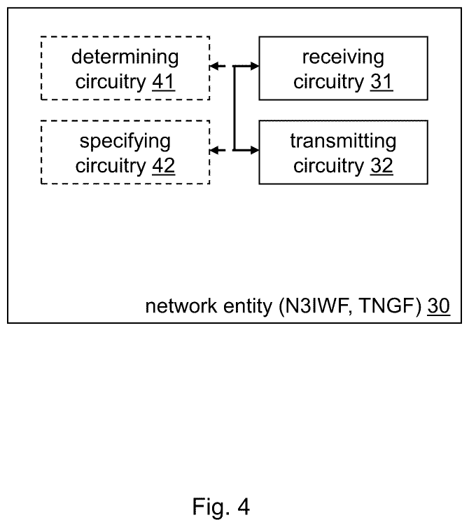

FIG. 4 is a block diagram illustrating an apparatus according to some example embodiments. In particular, FIG. 4 illustrates a variation of the apparatus shown in FIG. 3. The apparatus according to FIG. 4 may thus further comprise a determining circuitry 41 and/or a specifying circuitry 42.

In an example embodiment, at least some of the functionalities of the apparatus shown in FIG. 3 (or FIG. 4) may be shared between two physically separate devices forming one operational entity. Therefore, the apparatus may be seen to depict the operational entity comprising one or more physically separate devices for executing at least some of the described processes.

According to a variation of the procedure shown in FIG. 10, additional operations are provided, which are inherently independent from each other as such. According to such variation, said congestion indication is an explicit congestion notification marking of uplink packets towards said network entity of said first network, and a method according to some example embodiments may comprise an operation of determining a rate of said explicit congestion notification marking of said uplink packets.

According to a variation of the procedure shown in FIG. 10, details of the transmitting operation (S102) are provided, which are inherently independent from each other as such. Such transmitting operation (S102) according to some example embodiments may comprise an operation of specifying said information corresponding to said congestion indication based on said rate.

According to further example embodiments, said uplink packets are outer internet protocol packets of a protocol stack structure including at least outer internet protocol packets and inner internet protocol packets contained in said respective outer internet protocol packets.

According to a variation of the procedure shown in FIG. 10, additional operations are provided, which are inherently independent from each other as such. According to such variation, a method according to some example embodiments may comprise an operation of receiving an enquiry on an ability to detect said congestion indication, and an operation of transmitting information on said ability to detect said congestion indication.

According to a variation of the procedure shown in FIG. 10, additional operations are provided, which are inherently independent from each other as such. According to such variation, a method according to some example embodiments may comprise an operation of receiving a low latency low loss scalable throughput indication indicative of at least one protocol data unit session being low latency low loss scalable throughput traffic, wherein in relation to said determining, said method considers only said at least one protocol data unit session being low latency low loss scalable throughput traffic.

According to further example embodiments, said first network is a 3GPP network. According to such example embodiments, said method is operable at or by a non-3GPP interworking function entity. According to such example embodiments, said entity external to said first network is an untrusted non-3GPP access entity. According to such example embodiments, said network entity is an access and mobility management function entity or a session management function entity or a user plane function entity.

According to further example embodiments, said first network is a 3GPP network. According to such example embodiments, said method is operable at or by a trusted non-3GPP gateway function entity. According to such example embodiments, said entity external to said first network is a trusted non-3GPP access entity. According to such example embodiments, said network entity is an access and mobility management function entity or a session management function entity or a user plane function entity.

According to a variation of the procedure shown in FIG. 10, additional operations are provided, which are inherently independent from each other as such. According to such variation, a method according to some example embodiments may comprise an operation of receiving a configuration to report congestion information to said user plane function entity, wherein said network entity is said user plane function entity.

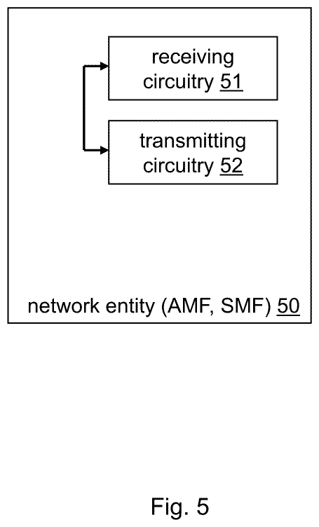

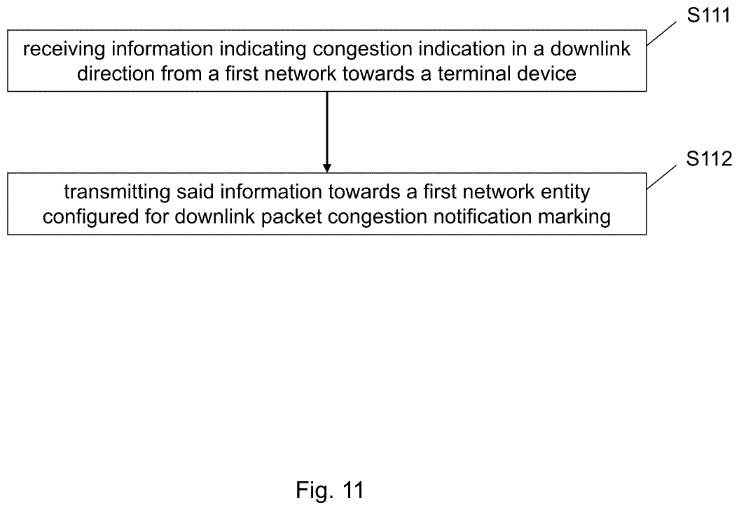

FIG. 5 is a block diagram illustrating an apparatus according to some example embodiments. The apparatus may be a network node or entity 50 such as a network entity (e.g. in a first network), e.g. an AMF, SMF, comprising a receiving circuitry 51 and a transmitting circuitry 52. The receiving circuitry 51 receives information indicating congestion indication in a downlink direction from a first network towards a terminal device. The transmitting circuitry 52 transmits said information towards a first network entity configured for downlink packet congestion notification marking. FIG. 11 is a schematic diagram of a procedure according to some example embodiments. The apparatus according to FIG. 5 may perform the method of FIG. 11 but is not limited to this method. The method of FIG. 11 may be performed by the apparatus of FIG. 5 but is not limited to being performed by this apparatus.

As shown in FIG. 11, a procedure according to some example embodiments comprises an operation of receiving (S111) information indicating congestion indication in a downlink direction from a first network towards a terminal device, and an operation of transmitting (S112) said information towards a first network entity configured for downlink packet congestion notification marking.

In an example embodiment, at least some of the functionalities of the apparatus shown in FIG. 5 may be shared between two physically separate devices forming one operational entity. Therefore, the apparatus may be seen to depict the operational entity comprising one or more physically separate devices for executing at least some of the described processes.

According to further example embodiments, said information corresponds to an explicit congestion notification marking of uplink packets towards a second network entity of said first network.

According to a variation of the procedure shown in FIG. 11, additional operations are provided, which are inherently independent from each other as such. According to such variation, a method according to some example embodiments may comprise an operation of transmitting, towards a third network entity, an enquiry on a third network entity's ability to detect an indication indicating said congestion indication in said downlink direction in uplink traffic, and an operation of receiving information on said third network entity's ability to detect said indication.

According to a variation of the procedure shown in FIG. 11, additional operations are provided, which are inherently independent from each other as such. According to such variation, a method according to some example embodiments may comprise an operation of transmitting, towards said first network entity, a low latency low loss scalable throughput indication indicative of at least one protocol data unit session being low latency low loss scalable throughput traffic. Alternatively, or in addition, according to such variation, a method according to some example embodiments may comprise an operation of transmitting, towards said third network entity, a low latency low loss scalable throughput indication indicative of at least one protocol data unit session being low latency low loss scalable throughput traffic.

According to further example embodiments, said first network is a 3GPP network. According to such example embodiments, said method is operable at or by an access and mobility management function entity or a session management function entity as said second network entity. According to such example embodiments, said first network entity is a user plane function entity. According to such example embodiments, said third network entity is an untrusted non-3GPP access entity.

According to further example embodiments, said first network is a 3GPP network. According to such example embodiments, said method is operable at or by an access and mobility management function entity or a session management function entity as said second network entity. According to such example embodiments, said first network entity is a user plane function entity. According to such example embodiments, said third network entity is a trusted non-3GPP access entity.

According to a variation of the procedure shown in FIG. 11, additional operations are provided, which are inherently independent from each other as such. According to such variation, a method according to some example embodiments may comprise an operation of transmitting, towards said user plane function entity, a configuration to accept congestion information reported by said third network entity. Alternatively, or in addition, according to such variation, a method according to some example embodiments may comprise an operation of transmitting, towards said third network entity, a configuration to report congestion information to said user plane function entity.

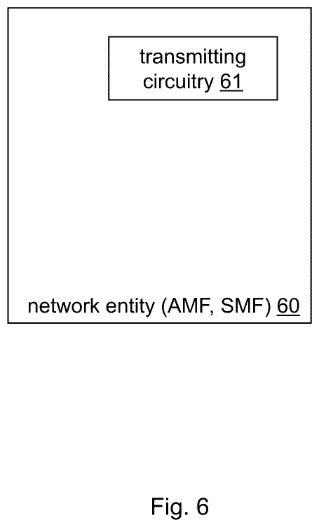

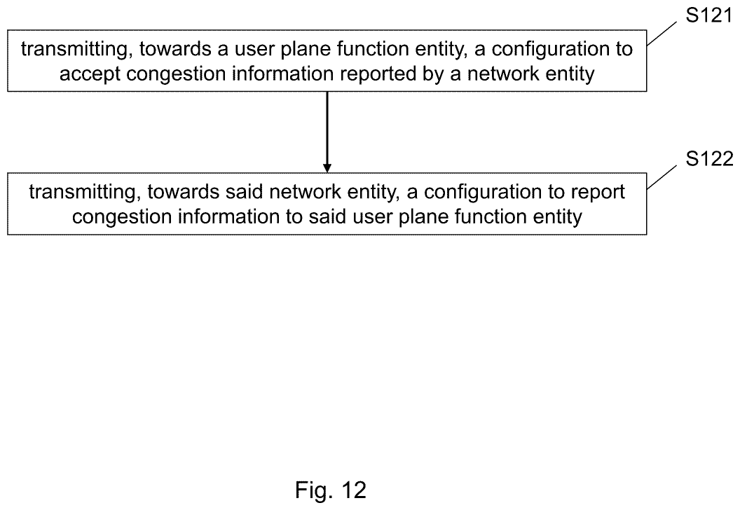

FIG. 6 is a block diagram illustrating an apparatus according to some example embodiments. The apparatus may be a network node or entity 50 such as a network entity (e.g. in a first network), e.g. an AMF, SMF, comprising a transmitting circuitry 61. The transmitting circuitry 61 transmits, towards a user plane function entity, a configuration to accept congestion information reported by a network entity. Alternatively, or in addition, the transmitting circuitry 61 transmits, towards said network entity, a configuration to report congestion information to said user plane function entity. FIG. 12 is a schematic diagram of a procedure according to some example embodiments. The apparatus according to FIG. 6 may perform the method of FIG. 12 but is not limited to this method. The method of FIG. 12 may be performed by the apparatus of FIG. 6 but is not limited to being performed by this apparatus.

As shown in FIG. 12, a procedure according to some example embodiments comprises an operation of transmitting (S121), towards a user plane function entity, a configuration to accept congestion information reported by a network entity, and/or an operation of transmitting (S122), towards said network entity, a configuration to report congestion information to said user plane function entity.

In an example embodiment, at least some of the functionalities of the apparatus shown in FIG. 6 may be shared between two physically separate devices forming one operational entity. Therefore, the apparatus may be seen to depict the operational entity comprising one or more physically separate devices for executing at least some of the described processes.

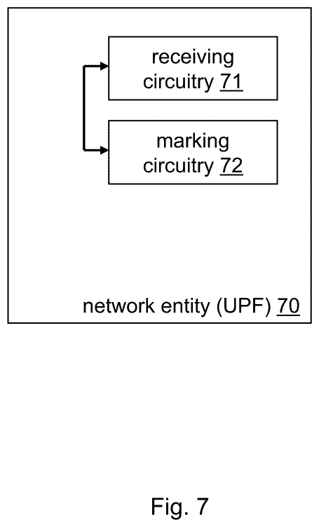

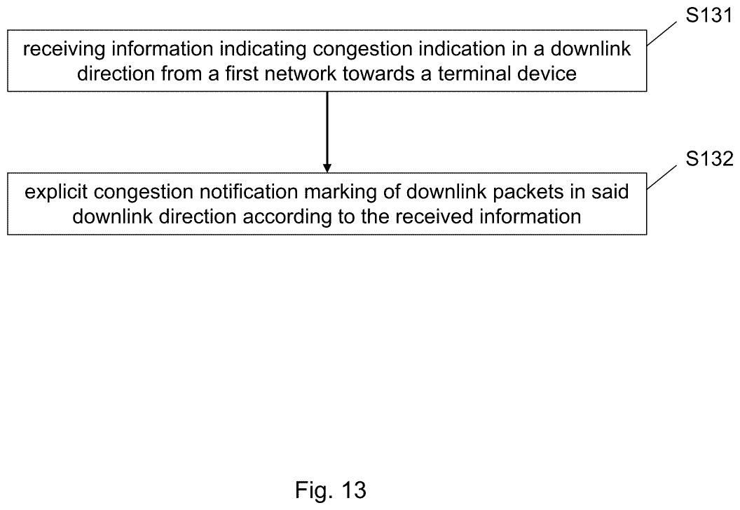

FIG. 7 is a block diagram illustrating an apparatus according to some example embodiments. The apparatus may be a network node or entity 70 such as a network entity configured for downlink packet congestion notification marking, e.g. an UPF, comprising a receiving circuitry 71 and a marking circuitry 72. The receiving circuitry 71 receives information indicating congestion indication in a downlink direction from a first network towards a terminal device. The marking circuitry 72 explicit congestion notification marks downlink packets in said downlink direction according to the received information. FIG. 13 is a schematic diagram of a procedure according to some example embodiments. The apparatus according to FIG. 7 may perform the method of FIG. 13 but is not limited to this method. The method of FIG. 13 may be performed by the apparatus of FIG. 7 but is not limited to being performed by this apparatus.

As shown in FIG. 13, a procedure according to some example embodiments comprises an operation of receiving (S131) information indicating congestion indication in a downlink direction from a first network towards a terminal device, and an operation of explicit congestion notification marking (S132) of downlink packets in said downlink direction according to the received information.

In an example embodiment, at least some of the functionalities of the apparatus shown in FIG. 7 may be shared between two physically separate devices forming one operational entity. Therefore, the apparatus may be seen to depict the operational entity comprising one or more physically separate devices for executing at least some of the described processes.

According to further example embodiments, said information corresponds to an explicit congestion notification marking of uplink packets towards a network entity of said first network.

According to further example embodiments, said information corresponds to a rate or number of said explicit congestion notification marking of said downlink packets.

According to a variation of the procedure shown in FIG. 13, additional operations are provided, which are inherently independent from each other as such. According to such variation, a method according to some example embodiments may comprise an operation of receiving a low latency low loss scalable throughput indication indicative of at least one protocol data unit session being low latency low loss scalable throughput traffic.

According to a variation of the procedure shown in FIG. 13, additional operations are provided, which are inherently independent from each other as such. According to such variation, a method according to some example embodiments may comprise an operation of receiving a configuration to accept reported congestion information.

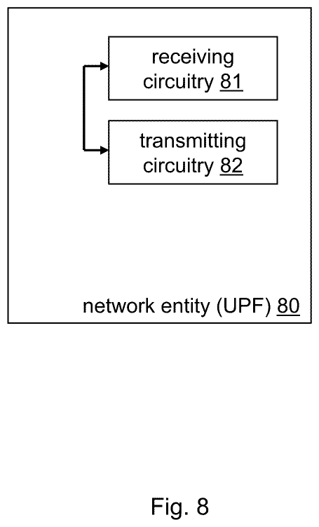

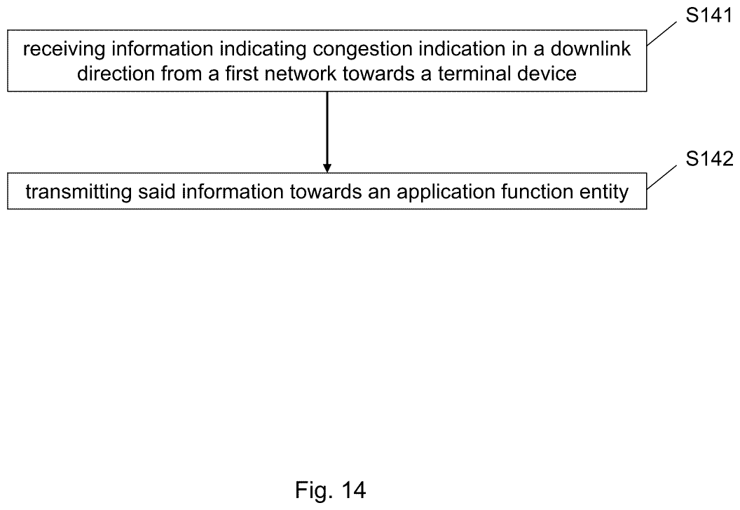

FIG. 8 is a block diagram illustrating an apparatus according to some example embodiments. The apparatus may be a network node or entity 80 such as a network entity configured for downlink packet congestion notification marking, e.g. an UPF, comprising a receiving circuitry 81 and a transmitting circuitry 82. The receiving circuitry 81 receives information indicating congestion indication in a downlink direction from a first network towards a terminal device. The transmitting circuitry 82 transmits said information towards an application function entity. FIG. 14 is a schematic diagram of a procedure according to some example embodiments. The apparatus according to FIG. 8 may perform the method of FIG. 14 but is not limited to this method. The method of FIG. 14 may be performed by the apparatus of FIG. 8 but is not limited to being performed by this apparatus.

As shown in FIG. 14, a procedure according to some example embodiments comprises an operation of receiving (S141) information indicating congestion indication in a downlink direction from a first network towards a terminal device, and an operation of transmitting (S142) said information towards an application function entity.

In an example embodiment, at least some of the functionalities of the apparatus shown in FIG. 8 may be shared between two physically separate devices forming one operational entity. Therefore, the apparatus may be seen to depict the operational entity comprising one or more physically separate devices for executing at least some of the described processes.

According to further example embodiments, said information corresponds to an explicit congestion notification marking of uplink packets towards a network entity of said first network.

According to further example embodiments, said information corresponds to a rate or number of said explicit congestion notification marking of said downlink packets.

According to a variation of the procedure shown in FIG. 14, additional operations are provided, which are inherently independent from each other as such. According to such variation, a method according to some example embodiments may comprise an operation of receiving a low latency low loss scalable throughput indication indicative of at least one protocol data unit session being low latency low loss scalable throughput traffic.

According to a variation of the procedure shown in FIG. 14, additional operations are provided, which are inherently independent from each other as such. According to such variation, a method according to some example embodiments may comprise an operation of receiving a configuration to accept reported congestion information.

Several example embodiments outlined and specified above are explained below in more specific terms.

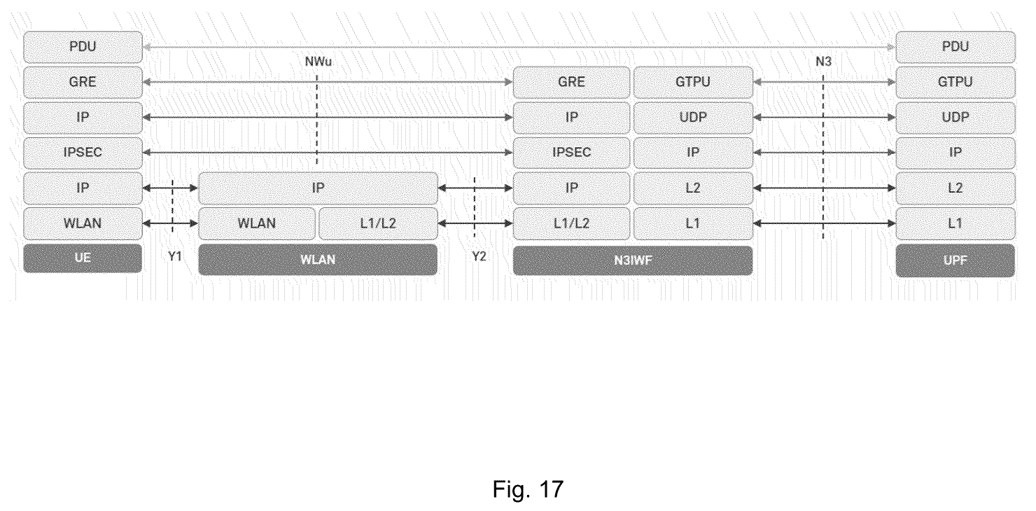

FIG. 17 shows a schematic diagram of an example of a protocol stack according to some example embodiments, and in particular illustrates a non-3GPP protocol stack for control and user planes for N3IWF.

With respect to the control plane (CP) protocol stack, it is noted that at the end of the registration procedure, a signaling IPsec SA is established between the UE and the N3IWF, after which the UE establishes a transmission control protocol (TCP)/IP connection with the N3IWF for the transport of non-access-stratum (NAS) messages over the inner IP address and the signaling IPsec SA. IPsec tunnel mode is employed for the signaling SA to protect and encrypt the original IP signaling packets and the port numbers used for communications of such IP packets.

With respect to the user plane (UP) protocol stack, it is noted that the UP protocol stack involves the protocols used in UE, WLAN, N3IWF, and UPF for transferring the UP traffic between the UE and data network. IPsec tunnel mode is employed for the established Child SAs to protect and encrypt the original IP user data packets and the port numbers used for communications of such IP packets.

It is further noted that the IP between WLAN and N3IWF is called outer IP, and the IP layer between the UE and the N3IWF is called inner IP. According to some example embodiments, the outer IP packets are used to indicate/send congestion information (regarding ECN-marked packets) between the WLAN and N3IWF.

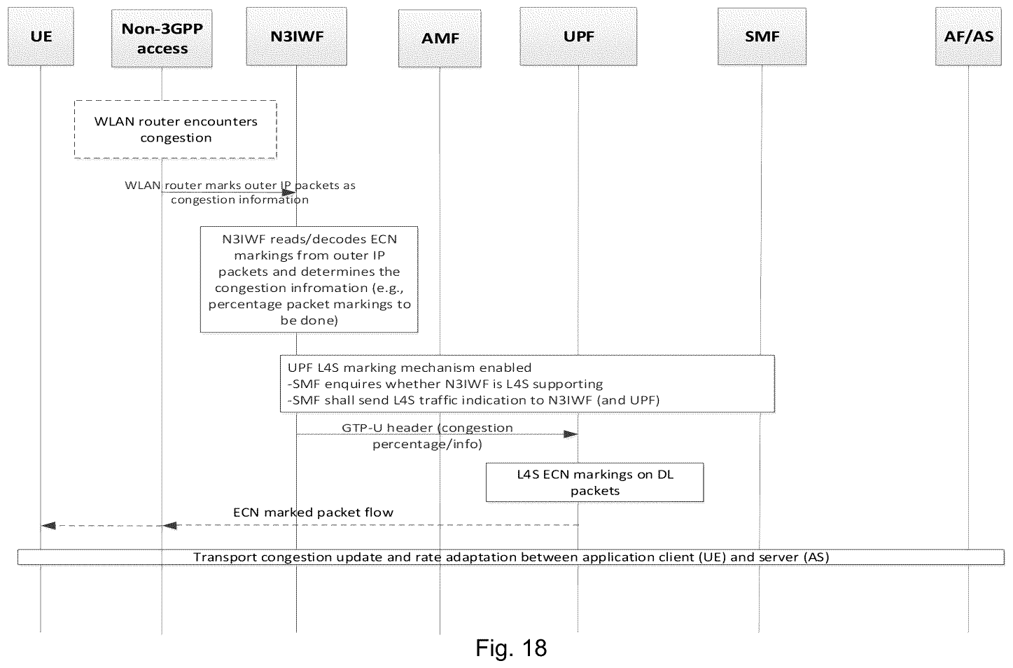

FIG. 18 shows a schematic diagram of signaling sequences according to some example embodiments, and in particular illustrates a call flow in relation to L4S congestion in non-3GPP access.

According to some example embodiments illustrated in FIG. 18, the WLAN experiences congestion. The WLAN router marks the outer IP (layer between WLAN and N3IWF only and transparent to AMF/UPF) packets with ECN bits.

The marking percentage can be calculated depending on the congestion level and UE DL traffic rate, etc.

According to some example embodiments, the PDU session specific outer IP addresses may be configured. (e.g., a separate IPSec tunnel for each PDU session of the UE).

According to some example embodiments, the N3IWF reads/decodes the ECN indications/packets in the UL direction (set by WLAN) and determines that WLAN is experiencing congestion in the DL direction. This functionality is not standard in N3IWF nodes and has to be enabled.

According to some example embodiments, the N3IWF is also able to identify L4S traffic/PDU sessions (SMF sends L4S indication).

With respect thereto, according to some example embodiments, the SMF queries the N3IWF about whether the N3IWF can read/decode the ECN indication (set by WLAN), and thus, ensures that the N3IWF can read/decode the ECN indication.

According to some example embodiments, the SMF enables the L4S detection and marking mechanism in the network.

This can be done in two ways:

Way 1. When the N3IWF reports congestion information (e.g., number of packets to be L4S ECN marked) to the SMF via the AMF (e.g., using PDU session resource setup via N1N2Msg), according to some example embodiments,
the SMF sends an L4S indication towards the N3IWF and the UPF (e.g., to indicate which PDU sessions are L4S traffic),
the SMF then forwards the congestion information to the UPF,
the UPF does the ECN marking to the DL packets as per the congestion information (percentage of packets to be marked for that DL PDU session),
alternatively, the UPF forwards the congestion information towards the AF using the above-discussed API exposure option.

Way 2. According to some example embodiments, the SMF configures N3IWF to report congestion information to UPF. The SMF also configures the UPF to initiate ECN marking when it receives congestion information from the N3IWF. Hence, according to some example embodiments, the N3IWF may directly report the congestion information to the UPF via GTP-U. The UPF, when it receives the congestion information, ECN marks the DL packets (alternatively, the UPF forwards the congestion information towards the AF using the above-discussed API exposure option). The N3IWF marks specific GTP-U header (i.e. specific PDU session) which are indicated to have carried L4S traffic by the SMF during PDU session resource creation. The N3IWF accepts the ECN marking from WLAN for only those IPSec SA tunnel which are mapped to PDU carrying L4S traffic.

According to some example embodiments, ECN-marked packets reach the UE (application client), and the UE (application client) informs about the congestion level to the sender application (AS).

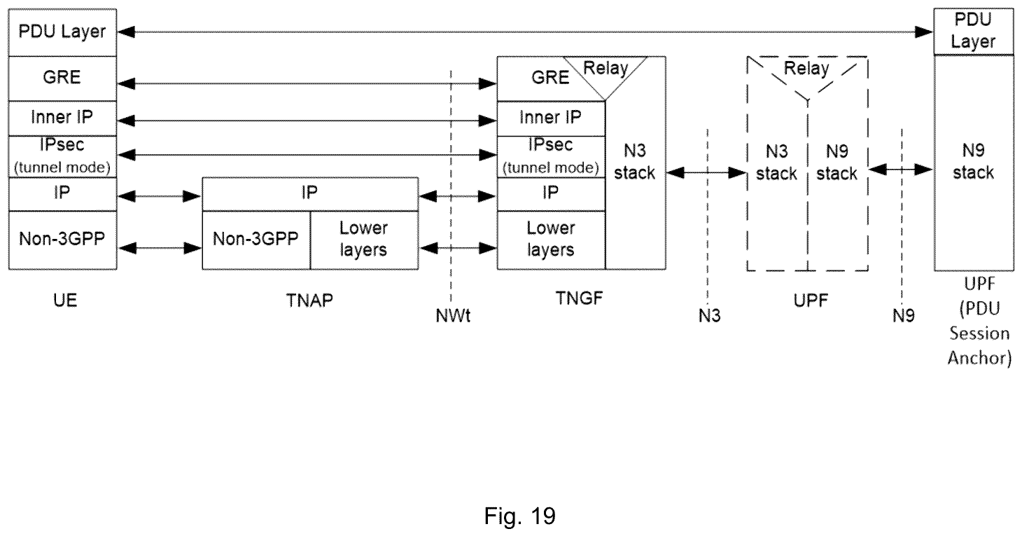

FIG. 19 shows a schematic diagram of an example of a protocol stack according to some example embodiments, and in particular illustrates a (5GC) non-3GPP protocol stack for TNGF.

That is, some example embodiments are equally applied to scenarios where a TNGF represents the gateway towards which the non-3GPP entity transmits the congestion information. The procedures/principles described above can thus be used also for such case.

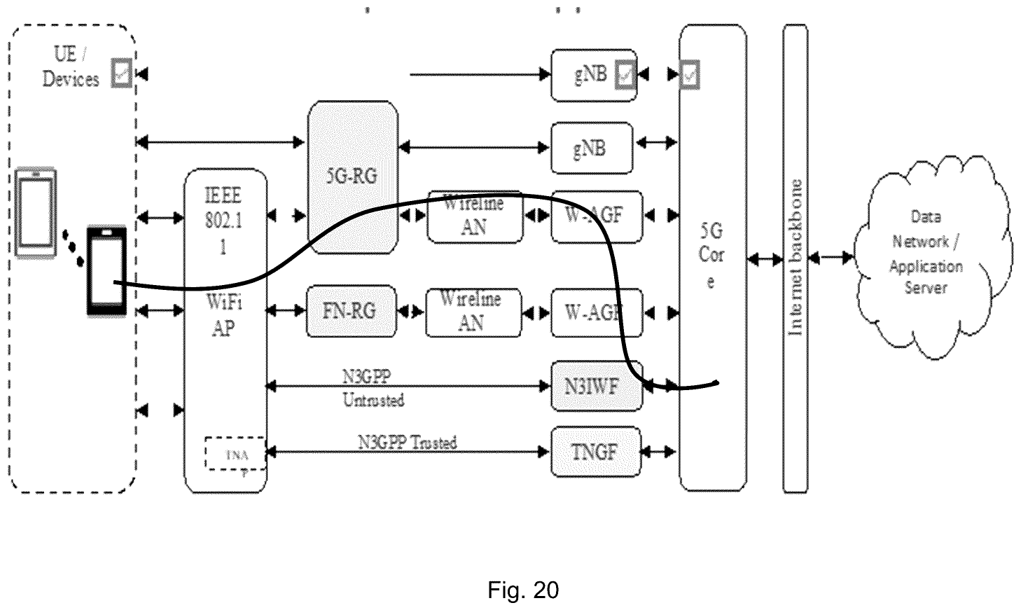

FIG. 20 shows a schematic diagram of an example of a system environment with signaling variants according to some example embodiments, and in particular illustrates a scenario deviating from the above-illustrated non-3GPP entry scenarios as follows.

In such scenario, a UE is connected through a WiFI access point (AP) or through an Ethernet (802.11) connection to a 5G residential gateway (5G-RG) device which is then connected to an N3IWF through an access network (AN) and a wireline access gateway function (W-AGF).

In this case, according to some example embodiments, the congestion information is sent via the 5G-RG towards the 5GC. The procedures/principles described above can thus be used also for such case.

Also, in a scenario in which the UE is connected via a fixed network residential gateway (FN-RG) device to the 5GC (i.e., FN-RG->wireline AN->W-AGF->N3IWF->5GC/UPF), the procedures/principles described above can thus be used also for such case.

The above-described procedures and functions may be implemented by respective functional elements, processors, or the like, as described below.

In the foregoing description of the network entity, only the units that are relevant for understanding facets of the subject disclosure have been described using functional blocks. The network entity may comprise further units that are utilized for its respective operation. However, a description of these units is omitted in this specification. The arrangement of the functional blocks of the devices is not construed to limit the subject disclosure, and the functions may be performed by one block or further split into sub-blocks.

When in the foregoing description it is stated that the apparatus, i.e. network node or entity (or some other means) is configured to perform some function, this is to be construed to be equivalent to a description stating that a (i.e. at least one) processor or corresponding circuitry, potentially in cooperation with computer program code stored in the memory of the respective apparatus, is configured to cause the apparatus to perform at least the thus mentioned function. Also, such function is to be construed to be equivalently implementable by specifically configured circuitry or means for performing the respective function (i.e. the expression “unit configured to” is construed to be equivalent to an expression such as “means for”).

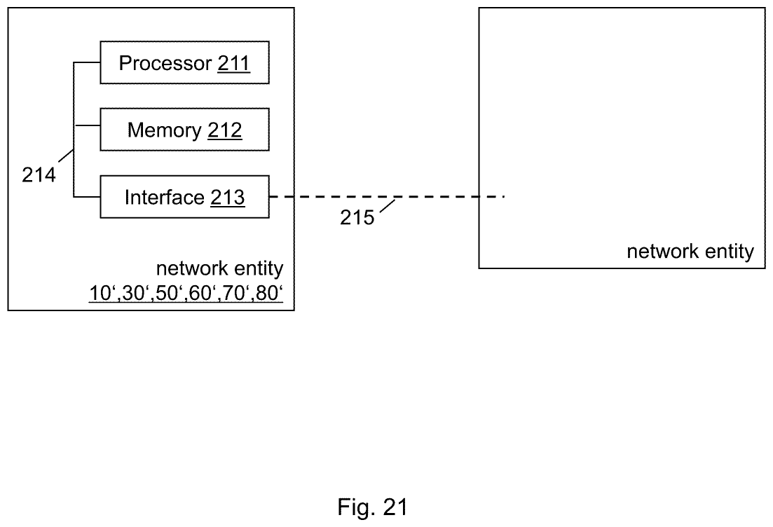

In FIG. 21, an alternative illustration of apparatuses according to some example embodiments is depicted. As indicated in FIG. 21, according to some example embodiments, the apparatus (network node or entity) 10′ (corresponding to the network node or entity 10) comprises a processor 211, a memory 212 and an interface 213, which are connected by a bus 214 or the like. Further, the apparatus (network node or entity) 30′ (corresponding to the network node or entity 30) comprises a processor 211, a memory 212 and an interface 213, which are connected by a bus 214 or the like. Further, the apparatus (network node or entity) 50′ (corresponding to the network node or entity 50) comprises a processor 211, a memory 212 and an interface 213, which are connected by a bus 214 or the like. Further, the apparatus (network node or entity) 60′ (corresponding to the network node or entity 60) comprises a processor 211, a memory 212 and an interface 213, which are connected by a bus 214 or the like. Further, the apparatus (network node or entity) 70′ (corresponding to the network node or entity 70) comprises a processor 211, a memory 212 and an interface 213, which are connected by a bus 214 or the like. Further, the apparatus (network node or entity) 10′ (corresponding to the network node or entity 80) comprises a processor 211, a memory 212 and an interface 213, which are connected by a bus 214 or the like. The apparatuses may be connected via link 215 respectively to another apparatus, e.g. one of the respective other apparatuses 10, 30, 50, 60, 70, 80.

The processor 211 and/or the interface 213 may also include a modem or the like to facilitate communication over a (hardwire or wireless) link, respectively. The interface 213 may include a suitable transceiver coupled to one or more antennas or communication means for (hardwire or wireless) communications with the linked or connected device(s), respectively. The interface 213 is generally configured to communicate with at least one other apparatus, i.e. the interface thereof.

The memory 212 may store respective programs assumed to include program instructions or computer program code that, when executed by the respective processor, enables the respective electronic device or apparatus to operate in accordance with the various example embodiments of the subject disclosure.

In general terms, the respective devices/apparatuses (and/or parts thereof) may represent means for performing respective operations and/or exhibiting respective functionalities, and/or the respective devices (and/or parts thereof) may have functions for performing respective operations and/or exhibiting respective functionalities.

When in the subsequent description it is stated that the processor (or some other means) is configured to perform some function, this is to be construed to be equivalent to a description stating that at least one processor, potentially in cooperation with computer program code stored in the memory of the respective apparatus, is configured to cause the apparatus to perform at least the thus mentioned function. Also, such function is to be construed to be equivalently implementable by specifically configured means for performing the respective function (i.e. the expression “processor configured to [cause the apparatus to] perform xxx-ing” is construed to be equivalent to an expression such as “means for xxx-ing”).

According to some example embodiments, an apparatus representing the network node or entity 10 comprises at least one processor 211, at least one memory 212 including computer program code, and at least one interface 213 configured for communication with at least another apparatus. The processor (i.e. the at least one processor 211, with the at least one memory 212 and the computer program code) is configured to perform detecting congestion indication in a downlink direction from a first network towards a terminal device (thus the apparatus comprising corresponding means for detecting), and to perform reporting said congestion information to a network entity of said first network (thus the apparatus comprising corresponding means for reporting).

According to some example embodiments, an apparatus representing the network node or entity 30 comprises at least one processor 211, at least one memory 212 including computer program code, and at least one interface 213 configured for communication with at least another apparatus. The processor (i.e. the at least one processor 211, with the at least one memory 212 and the computer program code) is configured to perform receiving, from an entity external to a first network, a report reporting congestion indication in a downlink direction from said first network towards a terminal device (thus the apparatus comprising corresponding means for receiving), and to perform transmitting information corresponding to said congestion indication towards a network entity in said first network (thus the apparatus comprising corresponding means for transmitting).

According to some example embodiments, an apparatus representing the network node or entity 50 comprises at least one processor 211, at least one memory 212 including computer program code, and at least one interface 213 configured for communication with at least another apparatus. The processor (i.e. the at least one processor 211, with the at least one memory 212 and the computer program code) is configured to perform receiving information indicating congestion indication in a downlink direction from a first network towards a terminal device (thus the apparatus comprising corresponding means for receiving), and to perform transmitting said information towards a first network entity configured for downlink packet congestion notification marking (thus the apparatus comprising corresponding means for transmitting).

According to some example embodiments, an apparatus representing the network node or entity 60 comprises at least one processor 211, at least one memory 212 including computer program code, and at least one interface 213 configured for communication with at least another apparatus. The processor (i.e. the at least one processor 211, with the at least one memory 212 and the computer program code) is configured to perform transmitting, towards a user plane function entity, a configuration to accept congestion information reported by a network entity (thus the apparatus comprising corresponding means for transmitting), and/or to perform transmitting, towards said network entity, a configuration to report congestion information to said user plane function entity.

According to some example embodiments, an apparatus representing the network node or entity 70 comprises at least one processor 211, at least one memory 212 including computer program code, and at least one interface 213 configured for communication with at least another apparatus. The processor (i.e. the at least one processor 211, with the at least one memory 212 and the computer program code) is configured to perform receiving information indicating congestion indication in a downlink direction from a first network towards a terminal device (thus the apparatus comprising corresponding means for receiving), and to perform explicit congestion notification marking of downlink packets in said downlink direction according to the received information (thus the apparatus comprising corresponding means for (explicit congestion notification) marking).

According to some example embodiments, an apparatus representing the network node or entity 80 comprises at least one processor 211, at least one memory 212 including computer program code, and at least one interface 213 configured for communication with at least another apparatus. The processor (i.e. the at least one processor 211, with the at least one memory 212 and the computer program code) is configured to perform receiving information indicating congestion indication in a downlink direction from a first network towards a terminal device (thus the apparatus comprising corresponding means for receiving), and to perform transmitting said information towards an application function entity (thus the apparatus comprising corresponding means for transmitting).

For further details regarding the operability/functionality of the individual apparatuses, reference is made to the above description in connection with any one of FIGS. 1 to 20, respectively.

For the purpose of the subject disclosure as described herein above, it should be noted that
method steps likely to be implemented as software code portions and being run using a processor at a network server or network entity (as examples of devices, apparatuses and/or modules thereof, or as examples of entities including apparatuses and/or modules therefore), are software code independent and can be specified using any known or future developed programming language as long as the functionality defined by the method steps is preserved;
generally, any method step is suitable to be implemented as software or by hardware without changing the idea of the example embodiments and its modification in terms of the functionality implemented;
method steps and/or devices, units or means likely to be implemented as hardware components at the above-defined apparatuses, or any module(s) thereof, (e.g., devices carrying out the functions of the apparatuses according to the embodiments as described above) are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components;
devices, units or means (e.g. the above-defined network entity or network register, or any one of their respective units/means) can be implemented as individual devices, units or means, but this does not exclude that they can be implemented in a distributed fashion throughout the system, as long as the functionality of the device, unit or means is preserved;
an apparatus, like the user equipment and the network entity/network register, may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the idea of the subject disclosure. Devices and means can be implemented as individual devices, but this does not exclude that they can be implemented in a distributed fashion throughout the system, as long as the functionality of the device is preserved. Such and similar principles are to be considered as known to a skilled person.

Software in the sense of the subject disclosure comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The subject disclosure also covers any combination of method steps and operations described above, and any conceivable combination of nodes, apparatuses, modules or elements described above, as long as the above-described concepts of methodology and structural arrangement are applicable.

In view of the above, there are provided measures for inter-network congestion reporting. Such measures may comprise (e.g. at a network gateway entity providing access to a network for a network external entity external to said network) receiving, from an entity external to a first network, a report reporting congestion indication in a downlink direction from said first network towards a terminal device, and transmitting information corresponding to said congestion indication towards a network entity in said first network.

Even though the subject disclosure is described above with reference to its various example embodiments according to the accompanying drawings, it is to be understood that the subject disclosure is not restricted thereto. Rather, it is apparent to those skilled in the art that the subject disclosure can be modified in many ways without departing from the various example embodiments as disclosed herein.

List of acronyms and abbreviations

| | |
|---|---|
| 3GPP | 3rd Generation Partnership Project |
| 5G | 5th Generation |
| 5GC | 5G core |
| 5G-RG | 5G residential gateway |
| AF | application function |
| AMF | access and mobility management function |
| AN | access network |
| AP | access point |
| API | application programming interface |
| AQM | active queue management |
| CE | congestion experienced |
| CP | control plane |
| DL | downlink |
| ECN | explicit congestion notification |
| ECT | ECN capable transport |
| FN-RG | fixed network residential gateway |
| GPRS | General Packet Radio System |
| GTP-U | GPRS tunnelling protocol user plane |
| IP | internet protocol |
| IPSec | IP security |
| L4S | low latency, low loss scalable throughput |
| NAS | non-access-stratum |
| NG-RAN | next generation radio access network |
| N3IWF | non-3GPP interworking function |
| PCC | policy and charging control |
| PCF | policy control function |
| PDU | protocol/packet data unit |
| PSA | PDU session anchor |
| QoS | quality of service |
| RTP | real time protocol |
| SBA | service-based architecture |
| SMF | session management function |
| TCP | transmission control protocol |
| TNGF | trusted non-3GPP gateway function |
| UE | user equipment |
| UL | uplink |
| UP | user plane |
| UPEAS | UPF enhancement for exposure and SBA |
| UPF | user plane function |
| W-AGF | wireline access gateway function |
| XR | eXtended reality |
| XRM | eXtended reality and media services |

1. An apparatus, comprising:
at least one processor;
at least one memory including computer program code; and
at least one interface configured for communication with at least another apparatus,
the at least one processor, with the at least one memory and the computer program code, being configured to cause the apparatus to perform:
detecting congestion indication in a downlink direction from a first network towards a terminal device, and
reporting said congestion information to a network entity of said first network.

2. The apparatus according to claim 1, wherein
in relation to said reporting, the at least one processor, with the at least one memory and the computer program code, being configured to cause the apparatus to perform:
explicit congestion notification marking of uplink packets towards said network entity of said first network.

3. The apparatus according to claim 2, wherein
said uplink packets comprise outer internet protocol packets of a protocol stack structure including at least outer internet protocol packets and inner internet protocol packets contained in said respective outer internet protocol packets.

4. The apparatus according to claim 2, wherein
the at least one processor, with the at least one memory and the computer program code, being configured to cause the apparatus to perform:
determining a number of explicit congestion notification markings based on a level of said congestion indication and on a rate of downlink packets from the first network.

5. The apparatus according to claim 1, wherein
said first network comprises a 3GPP network,
said apparatus is operable as or at an untrusted non-3GPP access entity, and wherein
said network entity comprises a non-3GPP interworking function entity.

6. The apparatus according to claim 1, wherein
said first network comprises a 3GPP network,
said apparatus is operable as or at a trusted non-3GPP access entity, and
said network entity comprises a trusted non-3GPP gateway function entity.

7. An apparatus, comprising:
at least one processor;
at least one memory including computer program code; and
at least one interface configured for communication with at least another apparatus,
the at least one processor, with the at least one memory and the computer program code, being configured to cause the apparatus to perform:
receiving, from an entity external to a first network, a report reporting congestion indication in a downlink direction from said first network towards a terminal device, and
transmitting information corresponding to said congestion indication towards a network entity in said first network.

8. The apparatus according to claim 7, wherein
said congestion indication comprises an explicit congestion notification marking of uplink packets towards said network entity of said first network, and wherein the at least one processor, with the at least one memory and the computer program code, being configured to cause the apparatus to perform:
determining a rate of said explicit congestion notification marking of said uplink packets.

9. The apparatus according to claim 7, wherein
said first network comprises a 3GPP network,
said apparatus is operable as or at a non-3GPP interworking function entity,
said entity external to said first network comprises an untrusted non-3GPP access entity, and
said network entity comprises an access and mobility management function entity or a session management function entity or a user plane function entity.

10. The apparatus according to claim 7, wherein
said first network comprises a 3GPP network,
said apparatus is operable as or at a trusted non-3GPP gateway function entity,
said entity external to said first network comprises a trusted non-3GPP access entity, and
said network entity comprises an access and mobility management function entity or a session management function entity or a user plane function entity.

11. An apparatus, comprising:
at least one processor;
at least one memory including computer program code; and
at least one interface configured for communication with at least another apparatus,
the at least one processor, with the at least one memory and the computer program code, being configured to cause the apparatus to perform:
receiving information indicating congestion indication in a downlink direction from a first network towards a terminal device, and
transmitting said information towards a first network entity configured for downlink packet congestion notification marking.

12. The apparatus according to claim 11, wherein
said information corresponds to an explicit congestion notification marking of uplink packets towards a second network entity of said first network.

13. The apparatus according to claim 11, wherein
the at least one processor, with the at least one memory and the computer program code, being configured to cause the apparatus to perform:
transmitting, towards a third network entity, an enquiry on a third network entity's ability to detect an indication indicating said congestion indication in said downlink direction in uplink traffic, and
receiving information on said third network entity's ability to detect said indication.

14. The apparatus according to claim 11, wherein
said first network comprises a 3GPP network,
said apparatus is operable as or at an access and mobility management function entity or a session management function entity as said second network entity,
said first network entity comprises a user plane function entity, and
said third network entity comprises an untrusted non-3GPP access entity.

15. The apparatus according to claim 11, wherein
said first network comprises a 3GPP network,
said apparatus is operable as or at an access and mobility management function entity or a session management function entity as said second network entity,
said first network entity comprises a user plane function entity, and
said third network entity comprises a trusted non-3GPP access entity.
